(19) United States
(12) Patent Application Publication
(10) Pub. No.: US 2010/0051132 A1
(43) Pub. Date: Mar. 4, 2010

(54) FABRIC

(76) Inventor: Robert Arthur Glenn, Leicestershire (GB)

Correspondence Address: MORGAN LEWIS & BOCKIUS LLP, 1111 PENNSYLVANIA AVENUE NW, WASHINGTON, DC, 20004, US

(21) Appl. No.: 12/449,301

(22) PCT Filed: Feb. 1, 2008
(86) PCT No.: PCT/GB2008/000345

§ 371 Date: Oct. 29, 2009

Related U.S. Application Data
(60) Provisional application No. 60/898,697, filed on Feb. 1, 2007.

(30) Foreign Application Priority Data
Feb. 1, 2007 (GB) 0701927.6

(51) Int. Cl. D03D 3/02; D04H 13/00; B32B 1/08; D03D 15/00; D04B 21/16; A41C 3/12

(52) U.S. Cl. 139/387 R; 156/148; 428/36.1; 139/420 R; 450/52

(57) ABSTRACT

The invention relates to a method for making a tubular fabric having an attachment flap for attachment to a second fabric, the method comprising providing a support yarn, a first fusible yarn and a second fusible yarn, wherein the yarns are formed into a tubular fabric having an attachment flap and the first fusible yarn is arranged so that, when it is melted and subsequently cooled, it forms a barrier in the tubular fabric to penetration by an underwire and the second fusible yarn is arranged in the attachment flap so that, in use, it can be fused to a second fabric.

The present invention relates to a tubular fabric, a method of making the same and to articles manufactured therefrom, particularly underwired garments such as a brassiere (bra).

It is known to produce fabric tubing for receiving a curved underwire. Conventionally such fabric tubing is made by forming three separate fabric strips. The strips are folded and sewn together to form a tube into which an underwire can be received.

Alternatively a curved underwire may be housed within a fabric tube comprising a support yarn, an elastomeric yarn and a fusible yarn which is arranged within the fabric tube so that it is capable of forming a penetration barrier, such as the fabric described in GB 2,309,038. Such tubular fabric addresses the problem of underwire protrusion which may occur with conventional fabrics, either during the course of garment manufacture or in use by a wearer, resulting in product failure which can be costly and have a deleterious effect on customer satisfaction.

Conventionally, once formed, tubular fabrics are incorporated into garments by sewing or stitching either before or after an underwire is inserted into the fabric tube. However, incorporating fabric tubes by sewing or stitching may spoil the aesthetics and/or comfort of the finished garment. There is an increasing demand for garments, such as “T-shirt” bras, in which stitching of a bra-wire casing is not visible.

The present inventors have found that a tubular fabric for housing an underwire can be incorporated into a garment by means of an attachment flap.

Accordingly, in a first aspect, the present invention provides a method for making a tubular fabric having an attachment flap for attachment to a second fabric, the method comprising the steps of providing a support yarn and a first fusible yarn, and forming the yarns into a tubular fabric having an attachment flap and having the first fusible yarn arranged so that, on subsequently melting and cooling of the first fusible yarn, the first fusible yarn forms a barrier in the tubular fabric to penetration by an underwire.

By “attachment flap” we include at least one piece of fabric which is connected to and projects from the fabric tube and which provides a surface that can be attached to a second fabric, thereby permitting attachment of the fabric tube onto a second fabric (such as the fabric of a garment). Preferably, the attachment flap comprises or consists of a single piece of fabric by may comprise or consist of more than once piece of fabric, such as two, three, four, five or more pieces of fabric, each piece connected to and projecting from the fabric tube and providing a surface that can be attached to a second fabric.

Preferably the attachment flap extends along the whole of the longitudinal axis of the fabric tube or substantially along the whole length of the longitudinal axis of the fabric tube. This arrangement permits attachment of the fabric tube along the whole, or substantially the whole, length of its longitudinal axis to a second fabric. The attachment flap is preferably formed as an integral part of the tubular fabric.

Preferably the attachment flap is the same or less than the width of the fabric tube. Exemplary attachment flap widths typically range from 15-25 mm, more preferably 17-24 mm, and especially 19 mm.

In preferred embodiments, the step of providing a support yarn and a fusible yarn may further include providing a second fusible yarn and the step of forming the yarns into a tubular fabric having an attachment flap may further include arranging the second fusible yarn in the attachment flap so that, in use, the attachment flap can be fused to a second fabric.

By “fusible yarn” we mean a yarn that can be melted above a first temperature and cooled to adhere to a support yarn or a second fabric. The term “fusible yarn” therefore includes a yarn having fusible or adhesive properties (for example, yarns having an adhesive surface) and which is capable of being melted above a first temperature and cooled to adhere to the support yarn.

The presence of the second fusible yarn in the attachment flap provides a means for attaching the attachment flap to a second fabric, such as the fabric of a garment. In particular, the attachment flap may be contacted with a second fabric and heated to a temperature which melts the second fusible yarn and allows it to spread over the yarns of the attachment flap and the second fabric; on cooling, the second fusible yarn sets and adheres the attachment flap to the second fabric.

In a particularly preferred embodiment, the first fusible yarn has a lower melting point than the second fusible yarn—the use of such yarns is preferable because it allows the tubular fabric having an attachment flap to be heated to a temperature which melts the first fusible yarn (and thereby allows a barrier to penetration by an underwire to be formed in the tubular fabric) but which does not melt the second fusible yarn. Thus, in that preferred embodiment, a tubular fabric can be formed which has a barrier to penetration by an underwire and which is capable of being fused to a second fabric by means of the attachment flap comprising a second fusible yarn.

In other embodiments, the second fusible yarn may be omitted and the method of the invention may further comprise the step of providing an adhesive on the attachment flap so that, in use, the attachment flap can be attached to a second fabric.

Such adhesive may include a hot-melt adhesive film such as, for example, the adhesive film known as Bemis Sewfree™ 3405.

The most preferred fusible yarn for use as a first fusible yarn and/or a second fusible yarn is a polyamide yarn, especially that sold by EMS-CHEMI AG of CH-7013 Domat/EMS, Switzerland under the name Grilon™.

Advantageously, the fusible yarn for use as a first fusible yarn and/or a second fusible yarn is in the form of a multifilament, preferably comprising 14 filaments.

Whilst fusible yarn in the form of monofilaments, such as those produced by Luxilon Industries in Belgium (under the trade name “Luxilon”), or Toray Industries in Japan, could be used in the present invention, a multifilament yarn is preferred for use as a first fusible yarn and/or a second fusible yarn because on melting it spreads more easily over the fabric. In contrast, the melting of a monofilament produces a less even spread which may be less comfortable to a wearer of a finished garment incorporating the tubular fabric of the invention.

An alternative fusible yarn to Grilon™ that may be used in the method of the invention is Bellcouple, which is manufactured by Kanebo Gohsen Limited in Japan. Bellcouple has is a bicomponent multifilament yarn which has a nylon or polyester core covered by a layer of fusible material (i.e. material with a low melting point). When heated at 160-190° C., the low-melting polyester in the sheath of Bellcouple melts and bonds multifilaments into resilient monofilament yarns.

The following types of Bellcouple are available:

| | Fineness | Strength | Elongation | Thermal Shrinkage |
|---|---|---|---|---|
| Type | (dT) | (CN/dT) | (%) | (%) |
| 56/24 LHD | 53.8 | 4.32 | 38.6 | 9.0 |
| (bright) | | | | |
| 84/24 LHD | 81.6 | 4.43 | 37.4 | 8.5 |
| (bright) | | | | |
| 167/16 LHC | 161.3 | 4.19 | 30.0 | 8.5 |
| (bright) | | | | |
| 28/01 LCO | 27.8 | 3.62 | 48.0 | 7.0 |
| (bright) | | | | |
| 26/01 LHC | 25.0 | 5.30 | 25.0 | 8.0 |
| (bright) | | | | |
| 33/01 LHC | 32.7 | 5.30 | 22.0 | 8.0 |
| (bright) | | | | |
| 280/16 LCO | 277.8 | 4.15 | 39.0 | 4.0 |
| (bright) | | | | |

Another fusible yarn which may be suitable for use in the method according to the invention is marketed as “Glurex” by Mipan/Hyosung.

Preferably, the first fusible yarn melts at less than 100° C., preferably 90° C. or less, more preferably a melting point of from 75° C. to 90° C., and can be cooled to produce a material having a higher melting point than the first temperature, and preferably more than 100° C. The most preferred first fusible yarn has a melting point of approximately 85° C.

A preferred fusible polyamide for use as a first fusible yarn is Grilon™ K-85, or a yarn which has substantially the same properties as Grilon™ K-85, which has a melting point of approximately 85° C. and a preferred yarn count dtex of 75. According to the manufacturer's technical data sheet Grilon™ K-85 has the following properties:—

| | |
|---|---|
| Melting range: | 78-88° C. (172-190° F.) |
| Application temperature range: | 95-120° C. (203-248° F.) |
| Melt viscosity DIN 53735, 160° C./21.6N: | 900 Pa · s |
| Yarn count: | 75 dtex 14 filaments |
| Tenacity: | 28 cN/tex |
| Elongation at break: | 40-70% |
| Twist: | 300Z T/m |
| Wash resistive: | 40° C. |
| Dry cleaning resistance: | PER-Chloro resistant |

A particular preferred feature of Grilon™ is that on cooling it retains a melting point “memory” for the temperature reached during the dyeing process i.e. after the dyeing process the melting point of the first fusible yarn changes from 85° C. to 100° C. or more. It will be appreciated that this feature confers the important advantage that the tubular fabric product will not deteriorate on washing by a user in a washing machine because the “new” melting point of the melted first fusible yarn will not be reached during normal washing.

A skilled person will understand that a first fusible yarn of the invention is intended to include any yarn which can melt at a predetermined temperature, preferably 70-90° C., more preferably 75-90° C., and adhere to other yarns of the fabric to form a penetration barrier. On cooling, the melted first fusible yarn preferably produces a coating, which has a melting temperature in excess of the predetermined temperature and preferably in excess of 100° C.

Preferably, the first fusible yarn is combined with a support yarn (such as Nylon or a textured Nylon) in order to strengthen the first fusible yarn, which may be advantageous during the process of fabric manufacture (for example, enabling machinery to be run at greater speed). Combining the first fusible yarn with a support yarn may also improve the spread of the fusible yarn within the fabric once it is melted. Methods for combining the fusible yarn with a support yarn will be well known to those skilled the art of fabric manufacture. A particularly preferred textured support yarn is 1/44/12 textured Nylon or 1/78/24 textured Nylon.

By “support yarn” we include any yarn that is used to form a basic structure of a fabric to which other yarn types may be added. Preferably, one or more support yarn is arranged in the warp and weft direction of a fabric and interwoven to form a basic fabric structure. Support yarns generally possess characteristics to maintain the integrity of a fabric structure—for example, they have minimal elasticity (unlike elastomeric yarns) and retain their form at relatively high temperatures (unlike fusible yarns).

Preferably, the support yarn is a polyamide, especially a textured polyamide. The support yarn is preferably composed of multifilaments. Preferred support yarns include Nylon 6 or Nylon 66 sold by Invista (formerly Du Pont), which comprises a 24 filament, textured polyamide yarn.

Preferably, the yarns are formed into a tubular fabric having an attachment flap by a weaving process. The tubular fabric could be produced by a knitting process employing a known fine gauge multi-bar warp or crochet knitting machine.

Preferably, the invention provides a method wherein the second fusible yarn is arranged in the attachment flap in the warp-direction. Alternatively, the second fusible yarn is arranged in the attachment flap in the weft-direction.

Preferably, the invention provides a method wherein the first fusible yarn is arranged in the fabric tube in the warp-direction. Alternatively, the first fusible yarn is arranged in the fabric tube in the weft-direction.

The terms “warp direction” and “weft direction” will be well understood to those skilled in the art of textiles manufacture. By “warp direction” we mean the length-ways direction of a fabric, and by “weft direction” we mean the width-ways direction of the fabric. Thus, by “arranged in the warp direction”, we mean that one or more yarn is arranged wholly or substantially along the length of the fabric (i.e. in the length-ways direction of the fabric).

A warpways arrangement of the first fusible yarn in the fabric tube has an additional advantage in that a sharp edge or point is not formed when the end of the fabric tube is cut. The fabric tube can therefore be incorporated directly into a garment and the cut end of the fabric tube worn comfortably, thereby removing the need for additional manufacturing steps (such as sewing over, or folding back, the end of the fabric tube) that have been used to improve the comfort of previous fabrics. Accordingly, a warpwise arrangement reduces the number of manufacturing steps and cost associated with incorporating a fabric tube into an underwired garment.

Preferably, the invention provides a method wherein the tubular fabric having an attachment flap further comprises an elastomeric yarn. An elastomeric yarn lends the fabric and attachment flap a desirable degree of flexibility or “give”, permitting the fabric to curve to receive an underwire. The term “elastomeric yarn” has a meaning well known in the art and a skilled person will appreciate that a range of elastomeric yarns could be employed. However, an elastane (e.g. Lycra™) is preferred both for its well proven performance and widespread commercial acceptance. Preferably, the elastane is covered with a polyamide yarn. A particularly preferred Lycra™ yarn is distributed by Wykes of Leicester, England, under their product code 2581 and comprises a core of 235 decitex (dtex) Lycra™ (Invista, formerly Du Pont) covered on top by 1 fold 78 dtex textured 18 filament Nylon 6 (Invista, formerly Du Pont) and on the bottom by 1 fold 78 dtex textured 18 filament Nylon 6 (Invista, formerly Du Pont).

In a preferred embodiment, the invention provides a method wherein the polyamide yarn is textured and, preferably, wherein the polyamide yarn is composed of a plurality of filaments.

The fabric of the invention may initially be made as an open or flat fabric that is subsequently formed into a tubular fabric.

The fabric tubing is preferably formed by weaving two fabric tapes. The tapes are overlaid and their edges joined by edge threads, rising from the bottom tape to the top tape and vice versa.

Each tape preferably has two weft threads (both of which are support yarns) inserted by one needle and knitted by a catch thread onto a latch needle.

It is possible to make a similar tubular fabric using a single weft needle. However, the production rate would be reduced significantly in comparison to the rate possible with a double weft needle. This is because the single needle would require approximately twice the number of picks to produce a fabric having the same strength as that produced by a double needle.

The weaving operation can be performed using a conventional narrow fabric loom. A preferred loom is produced by Jakob Müller AG, of Frick CH-5070 Frick, Switzerland and is known as Model Müller NF 6/27, and is fitted with a Müller NF system 3 catch thread attachment.

Preferably, threads are woven more loosely on one side (bottom) to produce “soft” surfaces for increased comfort to a subsequent wearer.

Preferably the yarns are textured for improved comfort and low shrinkage properties. Advantageously, the yarns are composed of multifilaments.

A particularly preferred polyamide yarn is 2 fold 78 dtex textured Nylon 6 or Nylon 66 comprising 20/23 air mingled filaments. These yarns are available from Invista (formerly Du Pont).

Preferably, the fusible yarn is 1 fold 75 dtex 14 filament Grilon™ K-85, available from EMS, Switzerland.

Preferably the fabric further comprises a catch thread which serves to make a smaller softer knitted edge. Conveniently, the catch thread comprises 1 fold 44 dtex air mingled 13 filament or a 78 dtex 23 filament 1 fold textured Nylon 6 or Nylon 66 (Invista, formerly Du Pont).

A skilled person will appreciate that the term decitex (dtex) refers to the thickness of the yarn. Yarns having a lower dtex than the preferred dtex mentioned above would produce a thinner fabric, which may be less comfortable to wear. Yarns with a higher dtex would produce a thicker fabric, which may be less flexible.

In the finished fabric weight the percentages of the different yarns are preferably in the ranges:—

(i) fusible yarn 4-10%, especially approximately 6%;
(ii) catch thread less than 1%; and
(iii) support yarn—balance to give 100%

If the fabric of the invention further comprises an elastomeric yarn, the percentage of elastomeric yarn in the finished fabric weight is preferably in the range:—

(iv) elastomeric yarn 0.5%-15%, especially 1-2%.

If monofilament yarn is used for the fusible yarn, more yarn may be required to achieve satisfactory spreading, and the preferred range is from 5-20%, especially approximately 10%.

Preferably, the yarns are pre-shrunk using conventional heat treatments/washing. This improves the dimensional stability of the final fabric product.

Importantly, fabric made in accordance with the method of the invention preferably displays minimal shrinkage when subjected to a normal washing process. Typically, fabrics made in accordance with the method of the invention preferably have a stability of −3.0% or less (preferably −1.5% or less). A stability value of −3.0% means that upon washing one metre of fabric shrinks to 97 cm. A stability value of −1.5% means that one metre of fabric shrinks to 98.5 cm. Excessive shrinkage of a fabric tube containing an underwire is undesirable because the fabric tube may shrink to a length similar to or less than the length of the contained underwire, which generates and/or increases the force of the underwire on the fabric tube and may lead to penetration of the underwire through the fabric tube.

The fabric of the invention comprises a first fusible yarn arranged so that, when it is melted and subsequently cooled, it forms a barrier in the tubular fabric to penetration by an underwire. Accordingly, the method of the invention preferably further comprises the step of treating the tubular fabric by heating and subsequently cooling the fabric to produce a barrier in the tubular fabric to penetration by an underwire. Conveniently, the treatment by heating comprises a polyamide fabric dyeing process, as described in more detail below, and wherein the temperature is preferably 100° C. or more.

Preferably, the first fusible yarn is treated by heating whereby it melts and spreads within the tubular fabric. On cooling, the fusible yarn adheres to the other yarns of the fabric to produce a fabric having a barrier to penetration by an underwire. It will be understood that the melted first fusible yarn adheres to the warp and weft yarns in the fabric and bonds those yarns to one another, thereby further stabilising and strengthening the fabric and preventing and/or reducing the weft yarns from being removed from the fabric.

In one embodiment, the first fusible yarn is arranged within the fabric so that, when heated, it melts and spreads over the interior surface of the tubular fabric so that, on cooling, it produces a fabric having a durable inner lining of the melted fusible yarn.

In another embodiment, the first fusible yarn is arranged within the fabric so that, when heated, it melts and spreads within the fabric (but does not spread over the interior or the exterior surface of the tubular fabric) so that, on cooling, it produces a fabric having a durable lining of the melted first fusible yarn within the fabric (but does not have a durable lining on the interior or exterior surface of the tubular fabric). Such an arrangement may be preferred as the durable lining will not be in contact with the body of individual wearing a garment having the tubular fabric which may improve the comfort of the garment.

Preferably, the invention provides a method comprising a step of treating the tubular fabric by heating and subsequently cooling the fabric to produce a barrier to penetration by an underwire. Advantageously, when the first fusible yarn and support yarns are polyamide, the treatment comprises a conventional polyamide fabric dyeing process, which involves temperatures in excess of the melting point of the fusible yarn.

Dyeing can be achieved using a continuous pad/steam process, or by a vat (exhaust dyeing) process. In both methods the process is preferably controlled so that the temperature does not fall below a predetermined temperature which is in excess of the melting point of the fusible yarn. The dyeing temperature is typically 100° C. or more.

After dyeing, the dyed fabric tubing is dried and cooled.

Conveniently, the fabric can be further treated with a normal dyed fabric finishing step such as acid treatment (using citric acid) to reduce the pH of the finished fabric to less than 4 and thereby protect the fabric from phenolic yellowing which can arise if the fabric is exposed to nitrogen oxide fumes.

The fabric tubing produced in accordance with the invention is extremely resistant to penetration by underwires.

Advantageously, in those embodiments including a second fusible yarn, the second fusible yarn has a melting point of 110° C. or greater, preferably a melting point of between approximately 110° C. and 140° C., more preferably a melting point of at least approximately 135° C. and even more preferably a melting point of at least approximately 140° C., and can be cooled to produce a material having a higher melting point than the first temperature, and preferably more than 110° C. The most preferred first fusible yarn has a melting point of approximately 140° C.

Accordingly, in such embodiments, the second fusible yarn will not melt under conditions capable of melting the first fusible yarn, such as those used during conventional dyeing processes. Accordingly, a dyed tubular fabric having a barrier to penetration can be formed with an attachment flap in which the second fusible yarn has not been melted—that tubular fabric may then be attached to a second fabric by means of the attachment flap by melting the second fusible yarn using the method of the invention.

The preferred fusible polyamide for use as a second fusible yarn is Grilon™ K-140, or a yarn which has substantially the same properties as Grilon™ K-140, which has a melting point of approximately 140° C. and a preferred yarn count dtex of 75.

The term “underwire” is intended to include any substantially rigid structural member and it need not be made from a metal. For example, a structural member formed from a substantially rigid plastic or from bone may be preferred in certain garments incorporating the tubular fabric of the invention. Such structural members are intended to fall within the scope of the term “underwire” as used herein. The terms “bra wire” and “underwire” are used interchangeably herein and will be understood by those skilled in the art to be synonymous.

By “barrier in the tubular fabric to penetration by an underwire” we include the meaning that: (i) an underwire is unable to pierce the surface of the tubular fabric; and/or (ii) an underwire is unable to pierce the surface of the tubular fabric and pass into the fabric; and/or (iii) an underwire is unable to pierce the surface of the tubular fabric and pass through the tubular fabric. Thus, the barrier to penetration will prevent and/or retard the passage of an underwire into, and/or through, the tubular fabric.

A person skilled in the art would be aware of methods capable of measuring the degree of penetration by an underwire through a fabric; for example, it may be measured by determining the force required to pass an underwire through a fabric (i.e. the penetration force). Such a test may be performed using a tensile tester, such as those produced by Houndsfield or Instron, which may be used to stretch the fabric to be tested to a specified modulus and determine the load (preferably in kg) required to pierce the fabric with an underwire or a needle of equivalent size. For example, the degree of penetration may be determined using a L+M Sewability Tester with a 90's medium ball needle to represent the underwire, as described in GB 2,309,038 and GB 2,366,574.

It will be understood that the force required to penetrate a fabric using such a method can be assigned a numerical value, which allows the degree of penetration exhibited by two or more fabrics to be compared.

Thus, by “barrier in the tubular fabric to penetration by an underwire” we also include the meaning that a first fabric is capable of preventing and/or retarding the passage of an underwire into, or through the fabric when the underwire is applied using a force which is capable of penetrating a second fabric that does not have a fusible yarn arranged to form a barrier to penetration by an underwire.

A fabric lacking a fusible yarn arranged to form a barrier to penetration by an underwire will typically resist a penetration force of 5 kg or less using the test method described in the accompanying Examples. Advantageously, the fabric of the invention will resist a greater penetration force than a fabric that does not have a fusible yarn arranged to form a barrier to penetration by an underwire—preferably, the fabric of the invention will resist a penetration force of 5 kg or more; preferably, 5 kg to 18 kg or 18 kg to 31 kg; even more preferably 18 kg or more; preferably 19 kg, 20 kg, 21 kg, 22 kg, 23 kg, 24 kg, 25 kg, 26 kg, 27 kg, 28 kg, 29 kg, 30 kg, 31 kg or more.

Thus, the fabric of the invention is preferably more than approximately two- or three- or four- or five- or six-times or more resistant to penetration by an underwire than a fabric lacking a fusible yarn arranged to form a barrier to penetration by an underwire.

It is preferred that the first and/or second fusible yarn, where present, and the support yarn are composed of the same material, advantageously a polyamide, so that they can be adhered to one another easily and so that their respective dyeing properties will be the same. A uniformity of dyeing throughout the fabric of the invention is an important commercial and aesthetic consideration.

Preferably, the invention provides a method further comprising the step of fusing or otherwise attaching the tubular fabric to a second fabric.

Conveniently, in embodiments wherein a second fusible yarn is provided, the step of fusing the tubular fabric to a second fabric comprises fusing the attachment flap to the second fabric by melting and cooling the second fusible yarn in the attachment flap.

In embodiments where a hot-melt adhesive is provided on the attachment flap, the step of attaching the tubular fabric to a second fabric preferably involves melting and cooling the hot-melt adhesive on the attachment flap.

In other embodiments a hot-melt adhesive film may be fed as a separate element between the attachment flap and the second fabric and, in such embodiments, the step of attaching the tubular fabric to a second fabric preferably involves melting and cooling the hot-melt adhesive on the attachment flap.

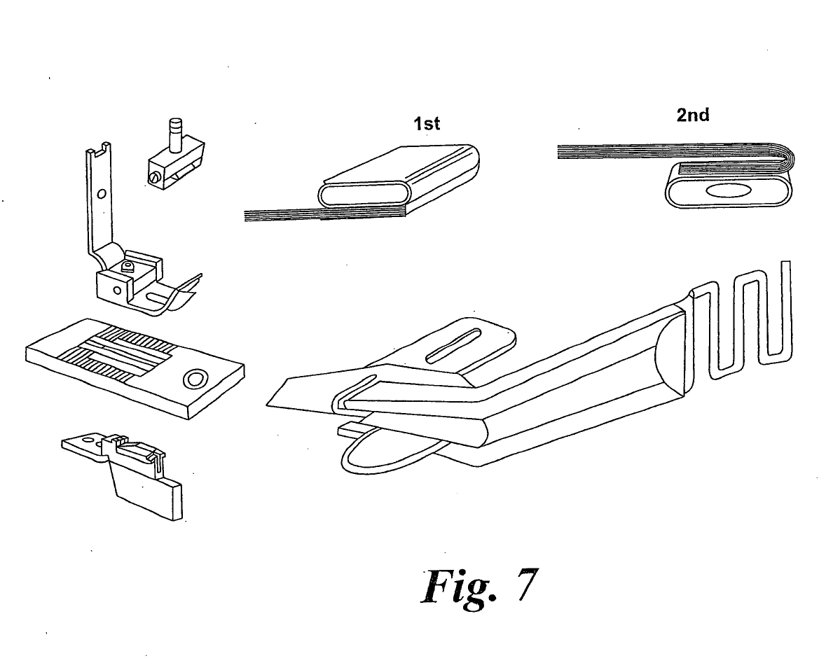

As shown in FIG. 7, the garment or second fabric is preferably sandwiched between the fusible flap and the fabric tube in what is known in the art as an “American binding” process.

Conveniently the second fusible yarn in the attachment flap or hot-melt film, whether provided on the attachment flap or provided as a separate element between the attachment flap and the second garment, may be heated by hot air.

Preferably, fusing or attaching the attachment flap to the second fabric involves pressing the attachment flap and the second fabric together by passing them through a nip roller.

Preferably, the step of fusing or attaching the tubular fabric to a second fabric is performed using machinery capable of contacting the attachment flap and the second fabric, heating the second fusible yarn in the attachment flap or the hot-melt adhesive by hot air, and passing the contacted attachment flap and second fabric through a nip roller.

Preferably heated belt feeds or heated rollers may be employed to maintain the application of heat whilst applying pressure.

Machinery suitable for performing that step are known in the art of textile manufacture and include, for example, the hemming machine described in WO 2004/095961 and produced by Sew Systems Limited (Nottingham, UK), or the heat-bonding machine produced by MACPI (Italy).

In yet further embodiments, adhesive provided on the attachment flap may not require heat in order to adhere the attachment flap to a second fabric and may simply require the application of pressure and thereby involve pressing the attachment flap and the second fabric together by passing them through a nip roller.

In other embodiments, the step of attaching the tubular fabric to a second fabric may involve applying an adhesive in the form of an uncured silicone adhesive to the attachment flap and/or the second fabric, applying pressure so as to sandwich the uncured silicone elastomer between the attachment flap and the second fabric and curing the uncured silicone elastomer so as to attach the attachment flap to the second fabric.

In such embodiments, curing of the uncured silicone elastomer may require the application of heat, which may be applied to the uncured silicone elastomer before it is applied to the attachment flap and/or the second fabric and may be applied in addition or alternatively once the attachment flap and the second fabric are brought into contact through the use of, for example, heated rollers or heated belt feeds.

It is envisaged that in other embodiments other uncured elastomers that, once cured, serve to adhere two layers of fabric together may be used in order to attach the tubular fabric to a second fabric.

Preferably, the second fabric is fabric of a garment, conveniently a garment selected from a bra, a basque or a swimming costume.

In a preferred embodiment, the method further comprises the step of locating an underwire within a length of the tubular fabric. Preferably, the step of locating an underwire within a length of the tubular fabric is performed before the step of fusing or otherwise attaching the tubular fabric to a second fabric but may be performed after the step of fusing or otherwise attaching the tubular fabric to a second fabric.

In a second aspect, the invention provides a tubular fabric having an attachment flap comprising a support yarn and a first fusible yarn; wherein the first fusible yarn is arranged in the tubular fabric so that, when it is melted and subsequently cooled, it forms a barrier in the tubular fabric to penetration by an underwire.

The tubular fabric may also include a second fusible yarn arranged in the attachment flap so that, in use, it can be fused to a second fabric.

Preferably, the tubular fabric of the second aspect of the invention is obtainable by the method of the invention.

In another aspect, the invention provides an open or flat fabric which is capable of being formed into a tubular fabric having an attachment flap comprising a support yarn and a first fusible yarn wherein the first fusible yarn is arranged in the tubular fabric so that, when it is melted and subsequently cooled, it forms a barrier to penetration by an underwire.

The open or flat fabric may also includes a second fusible yarn arranged in the attachment flap so that, in use, it can be fused to a second fabric.

Preferably, the open or flat fabric of the above aspect of the invention is obtainable by the method of the invention.

In a preferred embodiment, the tubular fabric of the invention comprises a first fusible yarn which has been melted and subsequently cooled to form a barrier in the tubular fabric to penetration by an underwire.

In a further aspect, the invention provides the use of a tubular fabric of the invention further in the manufacture of a barrier to penetration by an underwire.

In a further aspect, the invention provides a garment comprising a tubular fabric obtainable by a method of the invention; conveniently, the garment is selected from a bra, a basque or a swimming costume or another garment in which one or more underwire is present.

Preferred embodiments of the invention will now be described by way of non-limiting examples, with reference to the following drawings in which:—

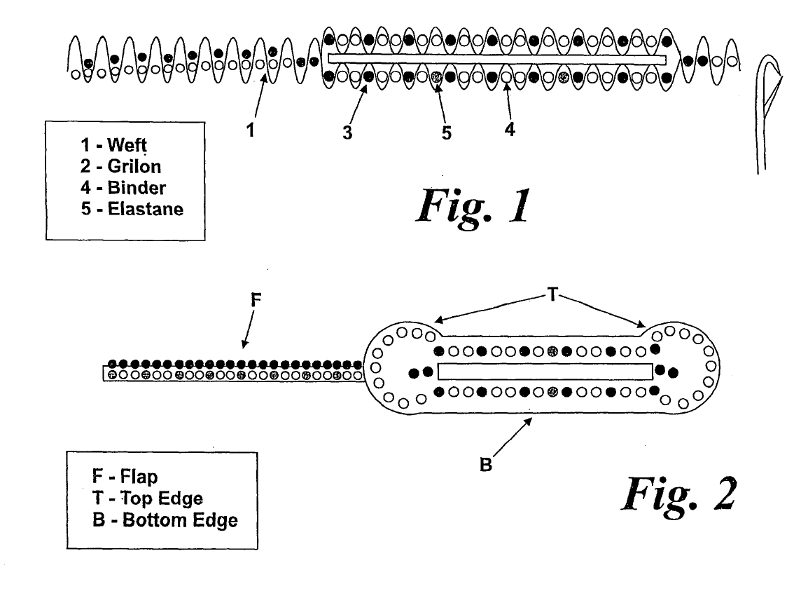

FIG. 1: Weft path within the tubular fabric having an attachment flap. The tubular fabric comprises an elastomeric yarn (Elastane).

FIG. 2: End view of the tubular fabric having an attachment flap (F), showing the bottom (B) and top (T) sides of the tubular fabric. The tubular fabric and the attachment flap comprise an elastomeric yarn. Preferably, the bottom of the tubular fabric and the edges of the top side of the tubular fabric (marked by arrows) are loosely constructed to further improve the soft feel of the fabric and comfort to the wearer.

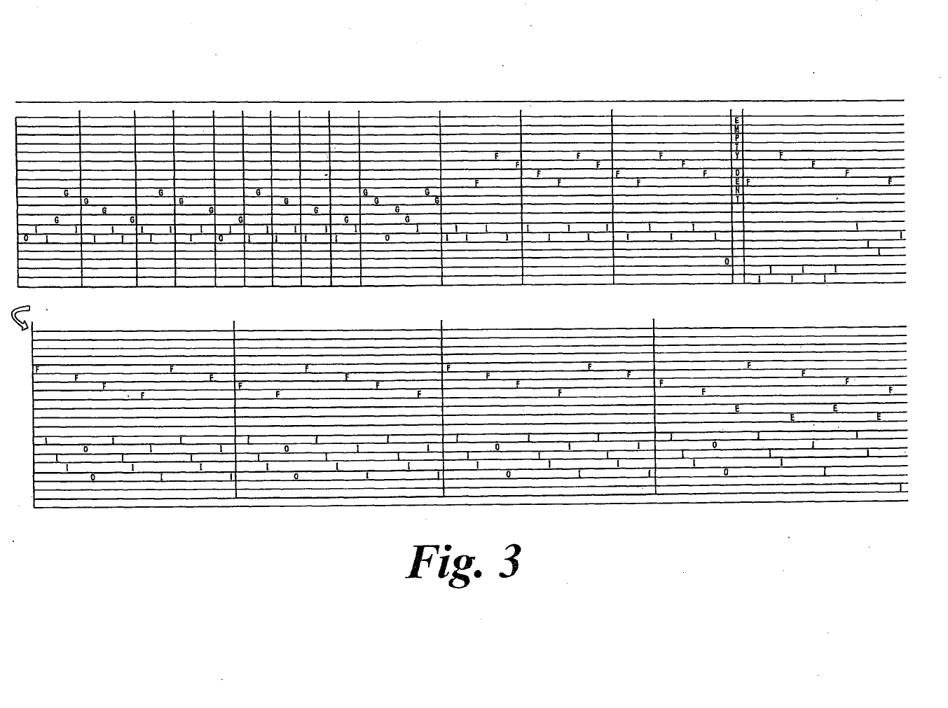

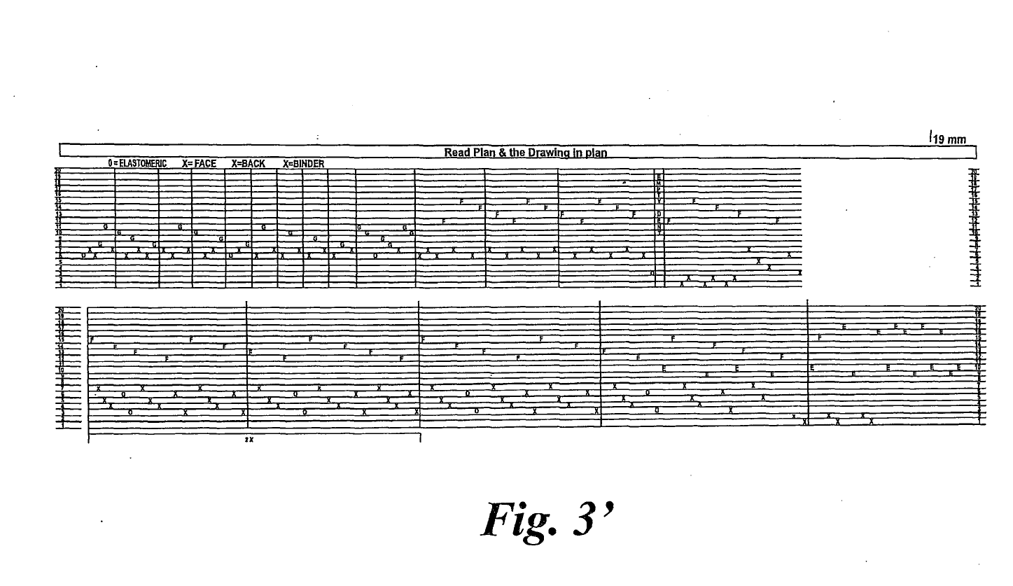

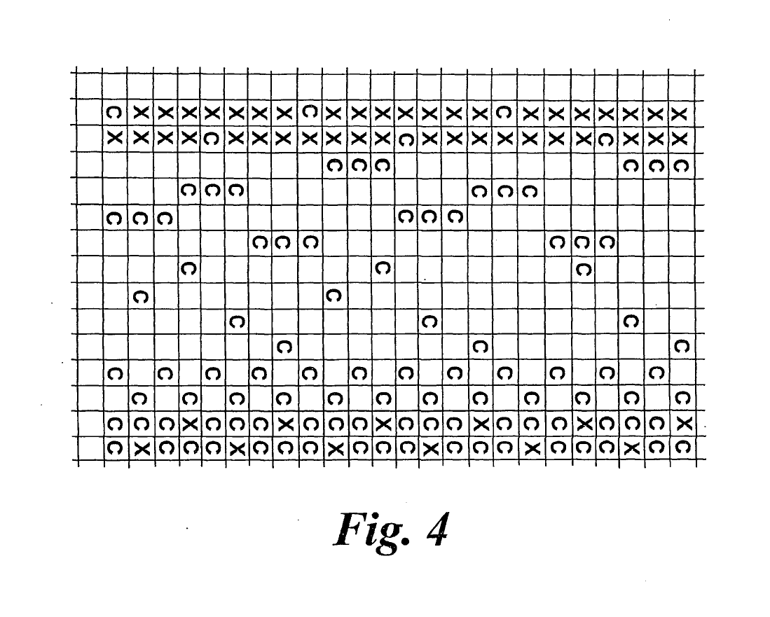

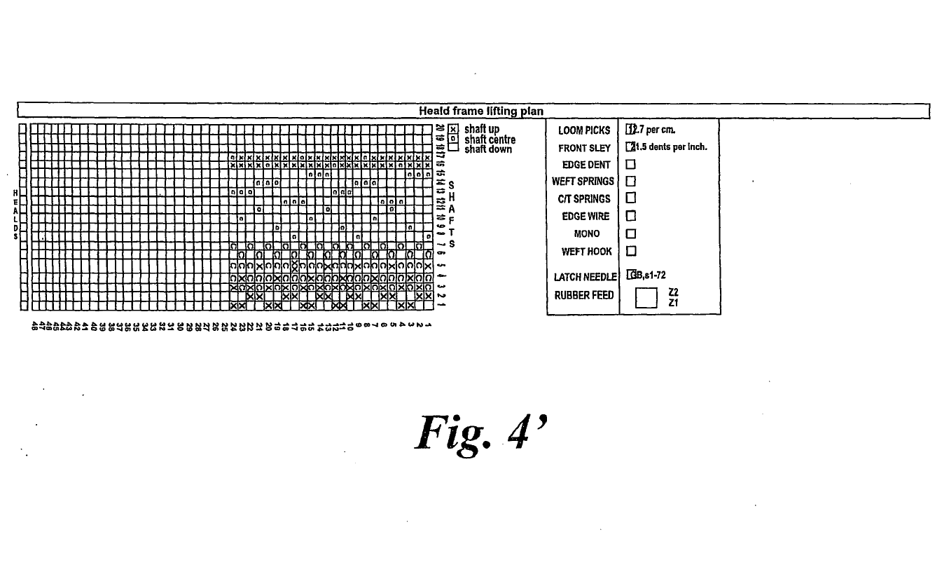

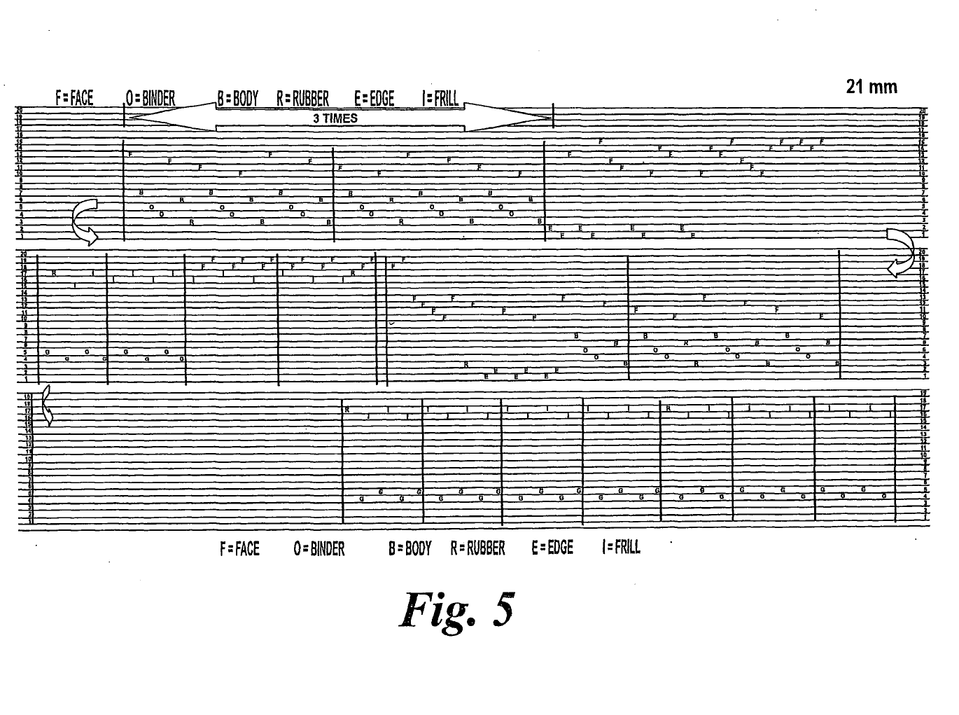

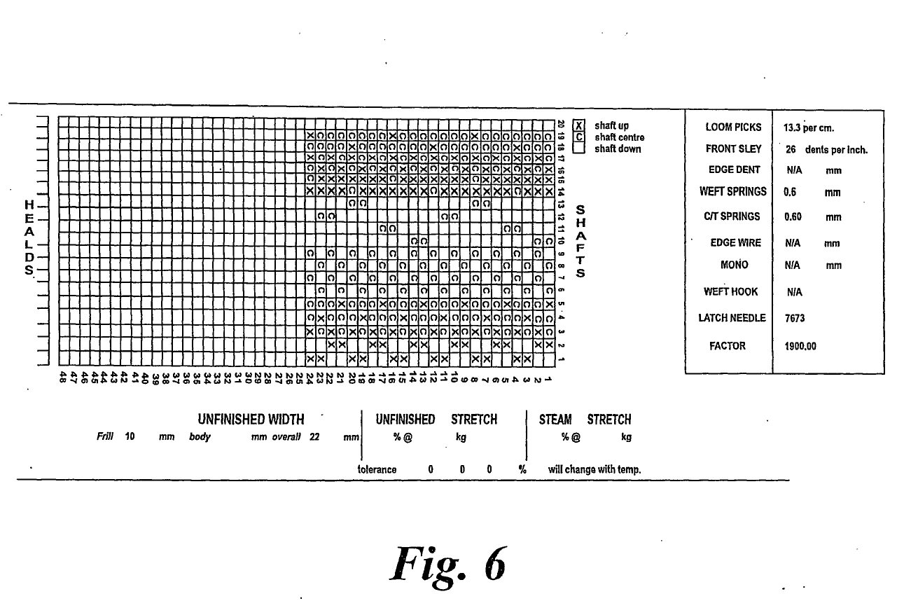

FIGS. 3-6: Drawing in Read and Heald plans for weaving the tubular fabric having an attachment flap according to the invention.

FIG. 7: Shows the folding machinery and (“American binding”) process by which a garment fabric is sandwiched and fused in a pocket formed between the tubular fabric body and attachment flap. The preferred machinery is available from Sew Systems Limited (Nottingham, UK), quoting its underwire system part No. AT260-comp and OB1 presser bar knife system.

### EXAMPLES

### Making Tubular Fabric

Details of how to make tubular fabric suitable for use in the invention are provided in the following documents: UK patent publication Nos. 2,309,038 and 2,366,574 (Price Shepshed Limited); and unpublished UK patent application No. 0621179.1 (Stretchline Holdings Limited). However, those documents do not describe the attachment flap feature of the present invention.

### Heat Treatment to Form a Barrier to Penetration by an Underwire

In the preferred method the heat treatment step is carried out by a conventional polyamide dyeing process. The vat dyeing process is preferred when the fabric is to be dyed with dark colours such as red, black or blue, whereas the continuous dyeing process is preferred for whites, creams and pastel colours.

A suitable continuous pad-steam dyeing process of the invention can be carried out with a conventional dyeing machine such as a MAGEBA™ Pad Steamer range produced by MAGEBA Textile machines GMBH & Co.

Preferably the conventional device is modified by the addition of a temperature sensing means which monitors the temperature within the dyeing machine. If the temperature falls below a predetermined level e.g. 90° C. (in excess of the melting point of the fusible Grilon™ yarn, an indicator such as a flashing light or buzzer is activated to warn an operator so that appropriate action can be taken to increase the temperature, as required.

Un-dyed tubular fabric of the invention is fed, at a rate of approximately 15 metres per minute, into the dye padding unit of the dyeing machine, which utilises a conventional polyamide dye (e.g. available from Hoechst, Ciba-Geigy, Clariant, Dye Star and Sandoz). The fabric then passes into the atmospheric steamer unit where the fusible Grilon™ yarn melts. The fabric is then passed into excess dye wash off baths, size tanks and into drying cylinders (e.g. a drying unit sold by Mageba).

Throughout the process the fabric is maintained under a fixed tension by means of appropriately positioned automatic dancer arms.

The fabric residence time in the steamer unit is 2-3 minutes, preferably 2.75 minutes at a temperature of from 100-105° C. The tubular fabric is dried uniformly whilst controlling the tension of the fabric so that the dimensional stability of the fabric is optimised.

In the vat dyeing process a known Pegg Pulsator or known exhaust dyeing machine can be used. This machine comprises a stainless steel tank in which a dyeing solution can be heated and stirred.

Fabric to be dyed is assembled into 50 metre hanks tied loosely with string bands. The hanks are put into a dyeing solution and heated until the solution boils (which melts the Grilon™ K-85 yarn). Boiling is preferably continued for at least approximately 45 minutes. The dyed fabric hanks are then removed from the tank, rinsed and dried.

A temperature control is used to warn the operator if the temperature falls below 90° C. during the boiling step.

The tubular fabric of the invention is particularly suitable for receiving underwires and is useful in the manufacture of a range of underwired garments including bras, basques and swimming costumes. The tubular fabric of the invention can be incorporated into a garment before or after the underwire is located.

### Penetration Force

The penetration force through the tubular fabrics of the invention may be measured according to the methods described in UK patent publication numbers 2,309,038; 2,366,574; and/or unpublished UK patent application No. 0621179.1 (Stretchline Holdings Limited).

Making Tubular Fabric with an Attachment Flap According to the Invention

The accompanying FIGS. 3 to 6 show the Read Plan; Drawing in plan; and the Heald frame lifting plan for making the preferred versions of the tubular fabrics with attachment flap by weaving according to the present invention.

FIG. 7 shows the use of machinery as described with reference to FIGS. 9 to 10 of WO2004/095961 (A D Turner Ltd.) to attach the tubular fabric with an attachment flap to a second fabric. As shown, the second fabric is sandwiched in a pocket formed between the tubular fabric and the attachment flap.

The fusible yarn of the attachment flap is melted by exposure to hot air and pressure applied via nip rollers (not shown) to fuse the flap to the second fabric.

The invention provides many benefits including a resistance to twisting of the underwire casing which is seen with conventional attempts to solve this bra wire casing problem.

The listing or discussion of a prior-published document in this specification should not necessarily be taken as an acknowledgement that the document is part of the state of the art or is common general knowledge.

1-62. (canceled)

63. A method for making a tubular fabric having an attachment flap for attachment to a second fabric, the method comprising the steps of
providing a support yarn and a first fusible yarn, and
forming the yarns into a tubular fabric having an attachment flap and arranging the first fusible yarn so that, on subsequent melting and cooling of the first fusible yarn, the first fusible yarn forms a barrier in the tubular fabric to penetration by an underwire.

64. The method according to claim 63 wherein the width of the attachment flap is the same or less than the width of the tubular fabric.

65. The method according to claim 63 wherein the step of providing a support yarn and a first fusible yarn further includes providing a second fusible yarn and the step of forming the yarns into a tubular fabric having an attachment flap further includes arranging the second fusible yarn in the attachment flap so that, in use, the attachment flap can be fused to a second fabric.

66. The method according to claim 65 wherein the first fusible yarn has a lower melting point than the second fusible yarn.

67. The method according to claim 63 further comprising the step of providing an adhesive on the attachment flap so that, in use, the attachment flap can be attached to a second fabric.

68. The method according to claim 67 wherein the adhesive is a hot-melt adhesive film.

69. The method according to claim 63 wherein the first fusible yarn is composed of multifilaments.

70. The method according to claim 65, wherein the first fusible yarn and the second fusible yarn are composed of multifilaments.

71. The method according to claim 63 wherein the first fusible yarn has a melting point of from 75° C. to 90° C.

72. The method according to claim 71 wherein the first fusible yarn has a melting point of approximately 85° C.

73. The method according to claim 65 wherein the second fusible yarn has a melting point of at least 110° C.

74. The method according to claim 65 wherein the second fusible yarn has a melting point of at least 140° C.

75. The method according to claim 63 wherein the step of providing at least a support yarn and a first fusible yarn further involves providing an elastomeric yarn, and the step of forming the yarns into a tubular fabric having an attachment flap further includes arranging the elastomeric yarn either in the tubular fabric, in the attachment flap, or in the tubular fabric and the attachment flap.

76. The method according to claim 63 further comprising the step of treating the tubular fabric by heating and subsequently cooling the fabric to produce a barrier in the tubular fabric to penetration by an underwire.

77. The method according to claim 76 wherein the treatment by heating comprises a polyamide fabric dyeing process.

78. The method according to claim 77 wherein the tubular fabric is heated to 100° C. or more.

79. The method according to claim 63 further comprising the step of fusing or attaching the tubular fabric to a second fabric.

80. The method according to claim 65 further comprising the step of fusing the tubular fabric to a second fabric by melting and cooling the second fusible yarn in the attachment flap.

81. The method according to claim 80 wherein the second fusible yarn in the attachment flap is heated by hot air.

82. The method according to claim 80 wherein the step of fusing the tubular fabric to the second fabric further comprises applying pressure to press the attachment flap and the second fabric together.

83. The method according to claim 80 wherein the attachment flap and second fabric are passed through a nip roller to apply pressure.

84. The method according to claim 68 further comprising the step of attaching the tubular fabric to a second fabric by melting and cooling the hot-melt adhesive on the attachment flap.

85. The method according to claim 84 wherein the hot-melt adhesive is heated by hot air.

86. The method according to claim 84 wherein the step of attaching the tubular fabric to the second fabric further comprises applying pressure to press the attachment flap and the second fabric together.

87. The method according to claim 86 wherein the attachment flap and second fabric are passed through a nip roller to apply pressure.

88. The method according to claim 79 wherein the step of fusing or attaching the tubular fabric to a second fabric involves feeding an adhesive film between the attachment flap of the tubular fabric and the second fabric and applying pressure so as to sandwich the adhesive film therebetween.

89. The method according to claim 88 wherein the adhesive film is a hot-melt adhesive film and heat is applied to the hot-melt adhesive film either prior to applying pressure, while applying pressure, or both prior to applying pressure and while applying pressure so as to sandwich the adhesive film therebetween.

90. The method according to claim 89 wherein hot air is blown onto the hot-melt adhesive film to pre-heat the hot-melt adhesive film prior to the application of pressure.

91. The method according to claim 89 wherein the hot-melt adhesive film is heated through the attachment flap and the second fabric by means of heated belt feeds or rollers through which the attachment flap and the second fabric are pressed.

92. The method according to claim 79 wherein the step of fusing or attaching the tubular fabric to a second fabric involves applying an uncured silicone elastomer onto either the attachment flap of the tubular fabric, the second fabric, or both the attachment flap of the tubular fabric and the second fabric, laying the attachment flap onto the second fabric, applying pressure so as to sandwich the uncured silicone elastomer therebetween and curing the uncured silicone elastomer to bond the attachment flap to the second fabric.

93. The method according to claim 92 wherein the uncured silicone elastomer is heated prior to its application onto either the attachment flap of the tubular fabric, the second fabric, or both the attachment flap of the tubular fabric and the second fabric.

94. The method according to claim 92 wherein curing the uncured silicone elastomer includes heating the uncured silicone elastomer through the attachment flap and the second fabric.

95. The method according to claim 63 further comprising the step of locating an underwire within a length of the tubular fabric.

96. A tubular fabric having an attachment flap comprising
a support yarn and
a first fusible yarn wherein
the first fusible yarn is arranged in the tubular fabric so that, on subsequent melting and cooling of the first fusible yarn, the first fusible yarn forms a barrier in the tubular fabric to penetration by an underwire.

97. A tubular fabric according to claim 96 further comprising a second fusible yarn arranged in the attachment flap so that, in use, the attachment flap can be fused to a second fabric.

98. A tubular fabric according to claim 96 further comprising adhesive provided on the attachment flap so that, in use, the attachment flap can be attached to a second fabric.

99. Use of a tubular fabric according to claim 95 in the manufacture of a barrier to penetration by an underwire.

100. A method of using a tubular fabric comprising:
providing a tubular fabric having an attachment flap, the tubular fabric including a support yarn and a fusible yarn, wherein the fusible yarn is arranged so that on subsequent melting and cooling of the fusible yarn, the fusible yarn forms a barrier in the tubular fabric to penetration by an underwire; and
joining the attachment flap of the tubular fabric to a garment.

101. A garment comprising a tubular fabric obtained by a method as claimed in claim 63.
